(19) United States
(12) Patent Application Publication
(10) Pub. No.: US 2007/0100697 A1
(43) Pub. Date: May 3, 2007

(54) Method and/or system for rendering service providers with relevant advertising and/or marketing information

(76) Inventor: Srinivas Kolla, Pittsburgh, PA (US)

Correspondence Address: Srinivas Kolla, 136 Thousand Oaks Drive, Pittsburgh, PA, 15241, US

(21) Appl. No.: 11/588,525

(22) Filed: Oct. 28, 2006

Related U.S. Application Data
(60) Provisional application No. 60/731,101, filed on Oct. 29, 2005.
(60) Provisional application No. 60/762,612, filed on Jan. 28, 2006.
(60) Provisional application No. 60/762,606, filed on Jan. 28, 2006.

(51) Int. Cl. G07G 1/14; G06Q 10/00

(52) U.S. Cl. 705/14; 705/2

(57) ABSTRACT

The main thrust of the present invention is to help pharmaceutical companies and medical device manufacturers (“pharma”) market their products more effectively to physicians (“Service Providers”). Products can be drugs, medical devices or health services that are used by physicians to treat patients. In the present invention, profile of a physician's treatment patterns, medications prescribed, services rendered, and other indices of physician practice are determined from an electronic health records (EHR) database that is then matched with the rules defined by pharma to determine the most relevant physician target for their product before displaying the product information (“Advertisement”) to the physician. Product Advertisements are shown in the same user interface that the physician uses to interact with the EHR database. Interacting with the displayed Advertisement, the physician can obtain additional product information from the system. Alternatively, through the Advertisement, the physician can also setup other means of communication with pharma to obtain more product information such as direct encounters with SRs or e-Detailing.

### CROSS REFERENCE TO RELATED APPLICATIONS

This application claims the benefit of U.S. Provisional Application No. 60/731,101 filed Oct. 29, 2005. the contents of which are hereby incorporated by reference. This application further claims the benefit of U.S. Provisional Application No. 60/762,612 filed Jan. 28, 2006. the contents of which are hereby incorporated by reference. This application further claims the benefit of U.S. Provisional Application No. 60/762,606 filed Jan. 28, 2006. the contents of which are hereby incorporated by reference.

### BACKGROUND OF THE INVENTION

1. Field of the Invention

The invention relates generally to advertising and/or marketing to service providers. For example, the invention may relate to the field of marketing products from pharmaceutical companies and medical device manufacturers to physicians.

2. Description of the Related Art

The traditional sales force model for pharmaceutical companies and medical device manufacturers (hereafter referred to collectively as “pharma”) in which sales representatives (SRs) provide information about products to physicians during direct encounters is fraught with inherent inefficiencies. This process called detailing is the interaction between a physician and SR in which the SR provides information about a product that the SR's company would like the physician to utilize. Given physicians' hectic schedules, it is reported that SRs detail physicians successfully only 12.5% of their intended interactions, with interactions lasting no longer than an average of two minutes. This results in an ineffective utilization of the SR's effort in accessing the physician and then allowing him only a brief encounter to provide relevant information. In addition, over the past 5 years, pharma have doubled their sales forces despite physician growth of only 15%, in an attempt to increase the interaction between SRs and physicians. However, this dramatic increase in the size of the sales forces has not been matched with appropriate levels of marketing training. This has resulted in SRs being able to provide only limited relevant information about products to physicians. This is further compounded by the fact that newer pharmaceuticals and devices are far more targeted for specific disease treatments and concomitantly require a higher level of skilled and trained SRs. This leads to physician frustration in dealing with SRs during brief detailing encounters, leaving physicians far less than optimally informed.

Against this backdrop, pharmaceutical companies are pursuing new and innovative techniques to detail physicians. One of the techniques is called electronic detailing (e-Detailing).

e-Detailing is a technology-based solution for providing product information and promotional material to physicians. It has evolved rapidly, over the past several years, and currently uses multiple channels of interaction (e.g. internet, video conferencing, etc.) to provide product information. Physicians can choose to engage in and learn about new pharmaceutical drug information at their own convenience. Pharma typically invites a chosen group of physicians to participate in an e-Detailing program. e-Detailing with its flexibility and convenience can be a relatively inexpensive and effective approach that can complement traditional detailing done by SRs.

For detailing, by direct encounter or by e-Detailing, to be useful and productive to both pharma and physicians, a dynamic understanding of physician practice patterns and behavior is critical. A physician practice profile (PPP) is an instrument which would provide information regarding physician treatment patterns, procedures performed, medications prescribed, as well as other indices of physician practice patterns. PPPs would change with time based on the changing patient demographics, newer therapeutic procedures and practices. A dynamic knowledge of a PPP would enable a pharma to segment the physician population for targeted marketing of their products. Direct encounters between SRs and physicians or e-Detailing encounters make it inherently very difficult to determine a PPP, let alone to know how it evolves over time.

Pharma currently use static data to determine product usage. Historically, new and overall prescription data obtained from pharmacy resellers has been used to gain understanding of product usage. Of late, there are some proposals about obtaining more patient-specific information from submitted pharmacy claims of prescriptions. Pharmacy benefit managers serve to link pharmacy claims data from different sources before transmitting them to the health insurance companies. They make this de-identified (de-identification involves the removal of confidential information such as name, address from the patient record and assigning a new and unique identifier) patient-specific data available commercially to pharma. This data, however, has only patient and physician identifiers, and drug and dosage information. It does not contain information on diagnoses, medical services provided or physician prescribing practices. Furthermore, this data does not provide insight into the practice profiles of physicians or how these profiles change over time. Health insurance companies can integrate medical and pharmacy claims data but the process is inherently challenging and untimely since the insurance claims data are usually available only after a 4 to 6 month time lag. Although the integrated claims data are rich in diagnoses, medical services and other information, the data lacks physician identifiers. It can be used for patient segmentation and prioritization but it is not useful for physician segmentation or building a PPP.

A way to address the difficulty of obtaining a PPP is to derive it from a physician utilized electronic health records (EHR) system. A well-designed physician utilized EHR system would allow physicians to interact with their patients health records efficiently and also generate rich longitudinal data on patient diagnoses, medical procedures and services performed, medications prescribed, and other indices of physician practice pertaining to patient care. It would be useful, therefore, to integrate an EHR system with a system that would provide relevant pharma product information to physicians. This would allow physicians and patients to benefit by allowing efficient access to health records in a paperless environment. In addition, it would allow pharma to benefit by allowing them dynamic insight into PPPs. This would then enable pharma to provide physician with relevant and timely product information which could be used to enhance the experience provided by direct encounters with SRs or by e-Detailing.

### SUMMARY OF THE INVENTION

Systems and methods consistent with the present invention address the pharmaceutical product marketing needs stated before by using an electronic health records (EHR) system for determining relevant product information which is then presented to a physician on the same system user interface (UI) he uses to interact with the EHR system.

The invention includes a computer system, on which there is a method comprising: providing a medical practice network structured and arranged for creating a physician practice profile and providing a pharmaceutical network structured and arranged for generating advertisements based on the physician practice profile.

The invention further comprises a physician practice management database in communication with the medical practice network.

The invention further comprises an electronic health records database in communication with the medical practice network.

The invention further comprises a rules and advertisements database in communication with the pharmaceutical network.

The invention further includes an apparatus, comprising a means for providing a medical practice network structured and arranged for creating a physician practice profile

The invention further includes an apparatus, comprising a means for providing a pharmaceutical network structured and arranged for generating advertisements based on the physician practice profile.

The invention further includes a computer system, comprising: a processor; and a memory in communication with the processor, the memory having stored thereon a set of data and instructions which, when executed by the processor, cause the processor to perform the steps of: providing a medical practice network structured and arranged for creating a physician practice profile and providing a pharmaceutical network structured and arranged for generating advertisements based on the physician practice profile.

The invention further includes a computer readable medium having stored thereon instructions which, when executed by a processor, cause the processor to perform the steps: providing a medical practice network structured and arranged for creating a physician practice profile and providing a pharmaceutical network structured and arranged for generating advertisements based on the physician practice profile.

The invention further includes a method, comprising: providing a medical practice network structured and arranged for creating a physician practice profile and providing a pharmaceutical network structured and arranged for generating advertisements based on the physician practice profile.

The invention further includes a method, comprising: establishing an electronic record or medium for maintaining and/or administering client services given by a provider; generating indices of services corresponding to said client services given by the provider; and directing solicitations to said provider based on said indices of services.

The invention further includes a computer assisted method, comprising: establishing an electronic record or medium for maintaining and/or administering client services given by a provider; generating indices of services corresponding to said client services given by the provider; and directing solicitations to said provider based on said indices of services.

The invention further includes an apparatus, comprising: means for establishing an electronic record or medium for maintaining and/or administering client services given by a provider;

The invention further includes means for generating indices of services corresponding to said client services given by the provider; and

The invention further includes means for directing solicitations to said provider based on said indices of services.

The invention further includes a computer system, comprising: means for establishing an electronic record or medium for maintaining and/or administering client services given by a provider;

The invention further includes means for generating indices of services corresponding to said client services given by the provider; and means for directing solicitations to said provider based on said indices of services.

The invention further includes 1) a method as disclosed and illustrated herein, 2) an apparatus as disclosed and illustrated herein, 3) a computer assisted method as disclosed and illustrated herein, 4) a network as disclosed and illustrated herein, and 5) a method for advertising as disclosed and illustrated herein.

### BRIEF DESCRIPTION OF THE DRAWINGS

FIG. 1 illustrates an embodiment of a physician practice network environment with an information management system in accordance with the invention.

FIG. 2 illustrates an embodiment of an electronic health records (EHR) database and the types of data it contains.

FIG. 3 illustrates an embodiment of the login window for physicians in a web browser to access the information management system that the physicians' network uses.

FIG. 4 illustrates an embodiment of the “home” page for a physician after he logs in successfully.

FIG. 5 illustrates an embodiment of a physician practice network environment with the System that can determine relevant pharmaceutical Advertisements from pharmaceutical companies and serve to different physicians in the network.

FIG. 6 illustrates an embodiment of a flow diagram of the stages involved in determining relevant Advertisements.

FIG. 7 illustrates an embodiment of the physician “home page” window rendered with relevant Advertisements determined by the system.

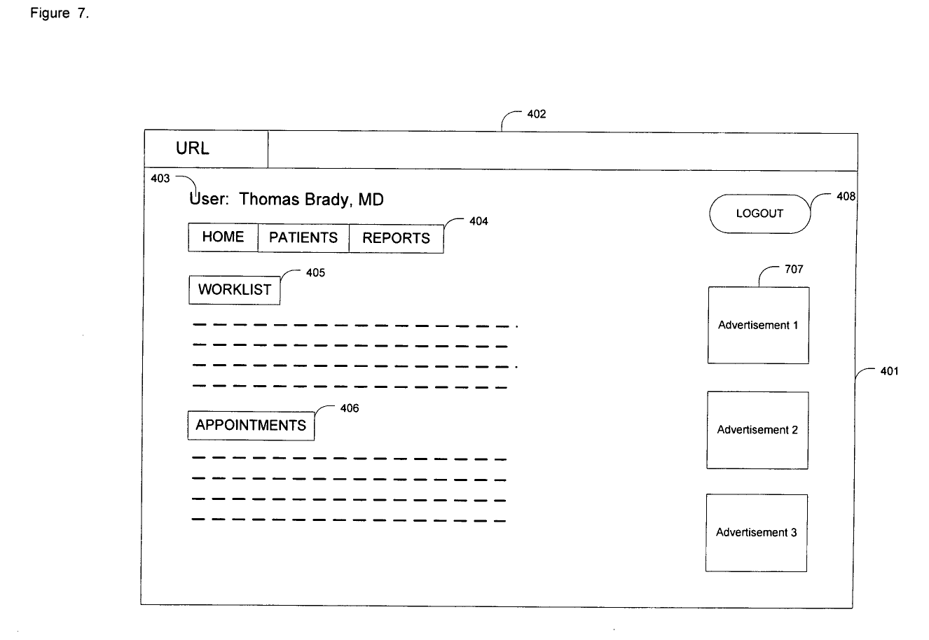

### DETAILED DESCRIPTION

The invention can be thought of in its most general embodiment, as using a electronic record or medium( for example, electronic health record) which engages service providers (for example, physicians) during their interaction with such a device. This allows a forum in which advertisement can be included for the purposes of informational content or sales.

Further, the invention can also be thought of as a broader concept, where an electronic record or medium aids in the maintenance and administration of client services given by providers and enables generation of indices of that provider's practice profile and allows specific solicitation directed to that provider based on these indices of practice. A specific application of this concept is detailed in this description as pertaining to electronic health records, physicians, and pharma.

Referring to the figures appended hereto, embodiments of the invention will be described in detail herein. It is to be understood that the figures and descriptions set forth herein of the present invention have been simplified to illustrate elements that are relevant for a clear understanding of the present invention, while eliminating, for purposes of clarity, other elements that may be typically found in a system incorporating the invention and/or a computer or computer network capable of implementing such a system. For example, specific operating system details and modules are not shown. Also, specific network items, such as, for example, network routers, are not shown. Those of ordinary skill in the art will recognize that other elements may be desirable to produce an operational system incorporating the present invention. However, because such elements are well known in the art, and because they do not facilitate a better understanding of the present invention, a discussion of such elements is not provided herein.

The present invention involves methods and system for determining relevant pharma product information (“Advertisements”) to be presented to physicians on the same user interface (UI) that is used to interact with an EHR system. Using the information contained in the EHR database about the patient diagnoses, procedures performed, medications prescribed, or other indices of physician practices, a detailed PPP is developed. The practice profile for any given physician can change over time; therefore, the system would periodically update the profiles for physicians to reflect the most recent practice patterns. Pharmaceutical companies would provide Advertisements and a set of rules under which they should be shown to a physician. The system would then compare the rules with the practice profile for a physician to determine the most relevant Advertisements that are then rendered to the UI.

Although the PPP is an instrument which can contain information about multiple indices of practice, it can be as simple as a single descriptor such as “specialty”. For example, if Dr. Alice Stone is a cardiologist, then the simplest PPP for this physician would be that her specialty is cardiology and site directed Advertisements that are specific to cardiology would be generated. A PPP can, therefore, include multiple indices of practice or simply limited to single descriptors, and can extend to any level of complexity as indices of practice profile are generated or derived over time.

People skilled in the art will recognize that many other implementations are possible, consistent with the present invention.

A. Physician Practice Network Environment

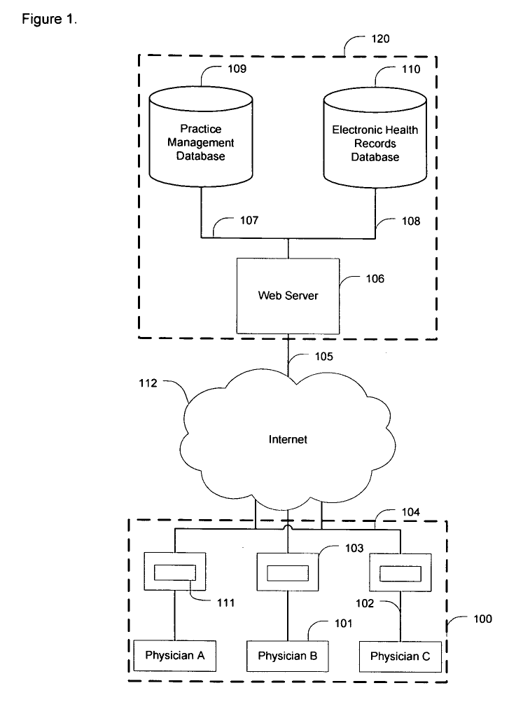

FIG. 1 shows an exemplary environment of a medical practice network 100 in which there can be one or more physicians who may not be located at the same physical location at any given time. A medical practice network 100 can be a business entity like a group practice or a group of physicians who may practice within a hospital network. An information management system 120 comprises two databases 109, 110 and a web server 106 in an embodiment of the invention. The information management system 120 is used to manage the practice management database 109 and the EHR database 110. An EHR database would enable a physician to create, store and retrieve patient records, order treatments and prescriptions for patients, etc. Practice Management Database 109 contains data specific to the operations of the network of physicians including, for example, contact management, billing, accounts payable, etc. One skilled in the art can see readily that the information management system 120 can have many different configurations with one or more databases, one or more application servers and one or more web servers providing the same functionality to individual physicians as delineated herein. In one embodiment of the medical practice network 100, a physician 101 can interact with the EHR database 110 or the Practice Management Database 109 using a web browser 111 that runs on a client device 103 that connects to the Internet 112 using a network 104. Web browser 111 is a standard web browser such as Internet Explorer, Firefox, or Netscape that provides a uniform user interface to physicians to access the information management system 120. A client device 103 can be a point-of-care device such as a tablet PC, PDA or can be a desktop PC or laptop PC that has a web browser 111 installed on it. Network 104 can be a LAN or a wireless network that connects to the Internet 112. Web server 106 can communicate with the databases 109 and 110 and connects to the Internet 112 using connection 105. Web server 106 mediates the data flow securely to and from the databases 109, 110 and the various web browsers 111 on the physician client devices 103.

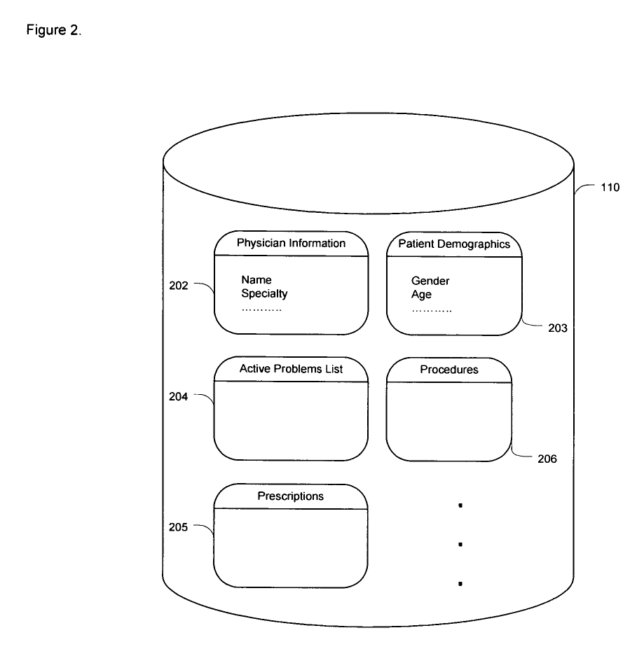

FIG. 2 shows the different types of data that may be contained in the EHR database 110. Physician Information table 202 contains data pertaining to each physician including name, specialty, sub-specialty, and other physician identifiers. Patient Demographics table 203 contains the demographic data including but not limited to name, address, age, gender for each patients that are treated by the physicians in the medical practice network 100. Active Problems List 204 table contains a running list of observations and diagnoses recorded by physicians for each of the patients. Procedures table 206 will contain procedures or services performed by the physician for a patient. Prescriptions table 205 contains the history of medications that were prescribed for each patient by the physicians. Those skilled in the art will recognize readily that the list of tables shown in the EHR database 110 is but a partial list of patient and practice specific information that may be stored in an EHR database. Patient data in the EHR database is confidential and is maintained according to the HIPAA (Health Insurance Portability and Accountability Act) rules for data security and confidentiality.

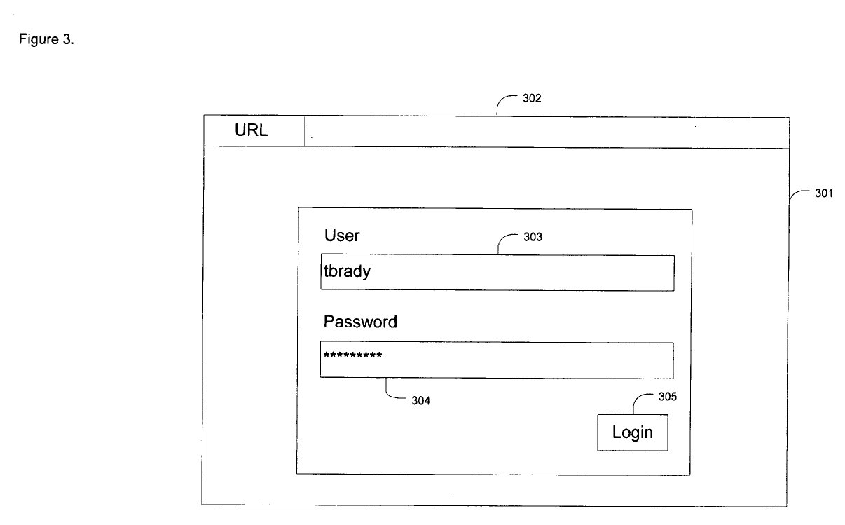

FIG. 3 shows an embodiment of a web browser login window 301 using which a physician 101 can login to access data from databases 109 and 110. The main elements of the login window 301 are a URL input element 302 to key-in the web site address of the web server 106, a user name input element 303, a password input element 304 and a login button 305. A physician would key-in his user id (e.g. “tbrady”) and a correct password in 303 and 304 respectively and upon clicking the login button 305, the web server would verify the correctness of the user id and password before displaying the exemplary homepage window 401.

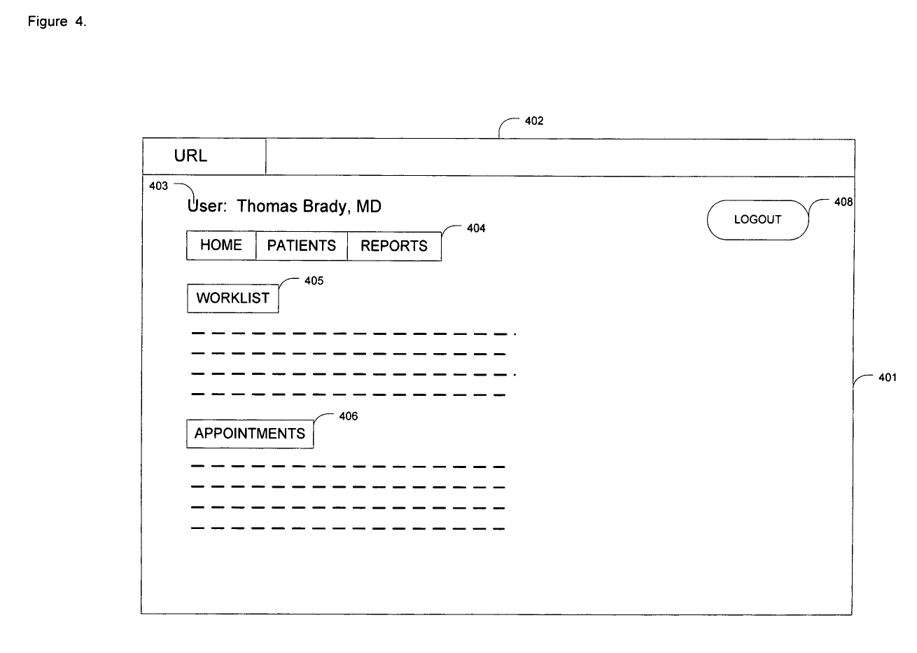

FIG. 4 shows an embodiment of a home page window for a user whose name (e.g. “Thomas Brady, MD”) is indicated 403. The main elements in this window may include, for example, a toolbar 404, “WORKLIST” 405 and “APPOINTMENTS” 406 and the logout button 408. The toolbar 404 is a standard web browser navigational device known to those skilled in the art and allows a user to access different data from the databases 109 and 110. “WORKLIST” 405 indicates all the pending tasks that the physician needs to address. The tasks are those that pertain to patient care, e.g. new patient or office visits, patient requests for prescription refills and referrals, etc. “APPOINTMENTS” 406 will show all the appointments that the physician has on that particular day. Data for “WORKLIST” 405 is accessed from the EHR database 110 while data for “APPOINTMENTS” 406 comes from the Practice Management Database 109. When a physician 101 clicks on the logout button 408 the current browser session will be disconnected securely from the web server 106.

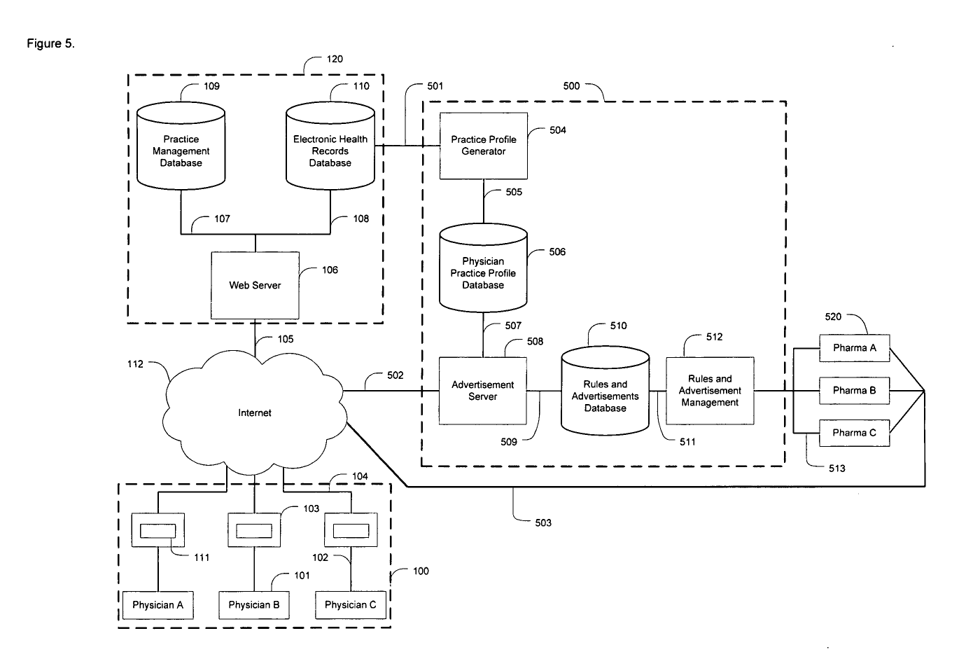

FIG. 5 illustrates an embodiment of a System 500 that interacts with both the Physician Practice Network Environment 100 through connection 502 which is in communication with, for example, an advertisement server and the pharmaceutical companies 520 via the connection 513 to enable the pharmaceutical companies to provide relevant product information to the physicians 101 in the network.

Practice Profile Generator (PPG) 504 is a system component that can generate a practice profile for a physician based on a set of rules. On a periodic basis (e.g. once a week), PPG would query the EHR database 110 to obtain for each physician in the network 100 a profile that shows patterns in demographics of the patients treated by that physician, medications provided, procedures performed, etc. For example, it may turn out that Dr. John Smith is a cardiologist who treats mostly middle-aged men with Type 2 diabetes for heart conditions. He has been prescribing drugs for hypertension. On the other hand, another physician, Dr. Alice Stone who is also a cardiologist performs mainly angioplasty and stent procedures. After PPG 504 generates these profiles for each of the physicians, it stores them in the database 506. With changing patient demographics, new treatments that may come about in time and for various other reasons, physician practice profiles (PPP) can change in time but at any given instant they can be used to characterize a physician's medical practice behavior to be able to provide to them relevant information on existing and new products from pharmaceutical companies. The practice profile data in the database 506 does not contain any information, confidential or otherwise, on individual patients belonging to the network 100. The data in the database 506 therefore is not subject to HIPAA regulations.

Pharma 520 can enter a set of rules as well as all the product information (“Advertisement”) into the Rules and Advertisement Management (RAM) 512 component in the system. A rule is a set of conditions under which an Ad may be shown to a physician. A rule can be as straightforward as having a single condition that the specialty of the physician needs to be met for a given Advertisement to be shown (e.g. a pharmaceutical company may want a specific Advertisement for their heartburn drug to be shown only to gastroenterologists). A more involved rule would be that an Advertisement for a drug be shown to only cardio-thoracic surgeons performing coronary artery bypass graft (CABG) procedures who have also prescribed drugs preventing perioperative blood loss. RAM 512 would allow a pharmaceutical company to define the rules and also modify them in time. These Ad rules would allow pharmaceutical companies to better target their products to a physician clientele that would be far more effective than any of the existing drug marketing techniques.

RAM 512 stores all the rules and the product information material (Advertisement material) in the database 510. Product information material includes, but is not limited to image, audio-visual, and pdf files that may be rendered or shown in a standard web browser such as Internet Explorer, Firefox, or Netscape. The database 510 where these files as well as the ad rules are stored can be a relational database such as Oracle or DB2.

Advertisement Server 508 performs the function of comparing the physician practice profile for a specific physician that has logged in using web browser 111 by accessing the database 506 with the Advertisement rules stored in the database 510 to find a match. Upon finding the match, the Advertisement Server 508 will render the corresponding Advertisement material from the database 510 to the web browser 111.

B. System Operation

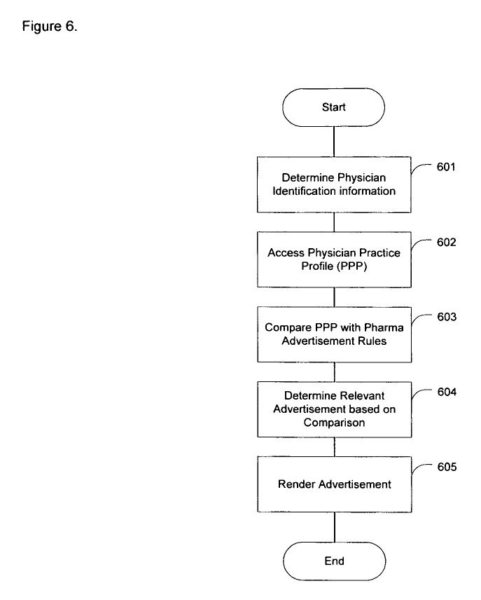

FIG. 6 is a flow diagram of an exemplary method for determining if an Advertisement is relevant and rendering it to the web browser using which a physician is currently accessing the EHR and PPM databases 109 and 110.

In Stage 601 of the process, the Advertisement Server 508 is provided with the physician login information from the login window 301. The Advertisement Server 508 which then accesses the database 506 to obtain the latest practice profile for that particular physician (Stage 602) and compares with all the rules stored in the database 510 (Stage 603). In Stage 604, the advertisement Server 508 will determine if there is match between the practice profile and an Ad rule. If there is a match (Stage 605), it will render the Advertisement or a plurality of Advertisements to the web browser 401.

Advertisement 707 displayed in the web browser 401 can be of two kinds, (a) informational or (b) interactive. If the Advertisement 707 is informational, when a physician clicks on 707, the Advertisement Server 508 will obtain from the database 510 additional informational files to be rendered in the web browser 401. If, on the other hand, the Ad 707 is interactive in nature, web browser 401 will connect via connection 503 to a web site belonging to the pharmaceutical company or one of its designated agent's (e.g. an e-Detailing company) website. A connection of this sort can be used to provide information in real time or to contact a sales rep belonging to the pharmaceutical company.

Consistent with the present invention, the Advertisement Server 508 can render relevant pharmaceutical Advertisements 707 to any web page constructed by the web server 106 and presented in the web browser 111 on the physician's client-device 103. The Advertisement Server 508 can also provide the relevant pharmaceutical Advertisements as pop-ups in the web browser 111 on the physician's client-device 103.

Whereas particular embodiments of this invention have been described above for purposes of illustration, it will be evident to those skilled in the art that numerous variations of the details of the present invention may be made without departing from the invention as disclosed and described herein and as defined in the appended claims.

1. A method, comprising:
establishing an electronic record or medium for maintaining and/or administering client services given by a provider;
generating indices of services corresponding to said client services given by the provider; and
directing solicitations to said provider based on said indices of services.

2. The method of claim 1, wherein said provider is a physician.

3. The method of claim 1, further comprising providing a physician practice management database in communication with a medical practice network.

4. The method of claim 1, further comprising providing an electronic health records database in communication with a medical practice network.

5. The method of claim 1, further comprising providing a rules and advertisements database in communication with a pharmaceutical network.

6. The method of claim 1, further comprising implementing said method on a computer system.

7. A method, comprising:
providing a medical practice network structured and arranged for creating a physician practice profile; and
providing a pharmaceutical network structured and arranged for generating advertisements based on the physician practice profile.

8. The method of claim 7, further comprising providing a physician practice management database in communication with the medical practice network.

9. The method of claim 7, further comprising providing an electronic health records database in communication with the medical practice network.

10. The method of claim 7, further comprising providing a rules and advertisements database in communication with the pharmaceutical network.

11. The method of claim 7, further comprising implementing said method on a computer system.

12. A computer system, comprising:
means for establishing an electronic record or medium for maintaining and/or administering client services given by a provider;
means for generating indices of services corresponding to said client services given by the provider; and
means for directing solicitations to said provider based on said indices of services.

13. The computer system of claim 12, further comprising a physician practice management database in communication with a medical practice network.

14. The computer system of claim 12, further comprising an electronic health records database in communication with a medical practice network.

15. The computer system of claim 12, further comprising a rules and advertisements database in communication with a pharmaceutical network.
